(19) United States
(12) Patent Application Publication
(10) Pub. No.: US 2020/0012766 A1
(43) Pub. Date: Jan. 9, 2020

(54) METHOD FOR AUTOMATICALLY GIVING ALARM AFTER ENCRYPTED DOCUMENT IS LEAKED

(71) Applicant: FUJIAN FOXIT SOFTWARE DEVELOPMENT JOINT STOCK CO., LTD., Fuzhou City (CN)

(72) Inventor: Peng Huang, Fuzhou City (CN)

(21) Appl. No.: 16/491,044

(22) PCT Filed: Apr. 1, 2017
(86) PCT No.: PCT/CN2017/000273

§ 371 Date: Sep. 4, 2019

(51) Int. Cl. G06F 21/16; G06F 21/60; G06F 9/54; G06F 21/62

(52) U.S. Cl. CPC G06F 21/16; G06F 21/602; G06F 2221/2115; G06F 21/6209; G06F 2221/2107; G06F 9/542

(57) ABSTRACT

A method for automatically giving an alarm after an encrypted document is leaked includes establishing a unique identifier for each protected document, and setting the unique identifier in the document. The unique identifier is uploaded to a cloud server, and the cloud server stores encrypted information corresponding to each document using the unique identifier as an index. When a third-party DRM system encrypts the document, the third-party DRM system uploads the unique identifier and current encrypted information to the cloud server, and the cloud server updates the encrypted information. When a user opens the document in a document reading client, the unique identifier is automatically uploaded with the encrypted information to the cloud server. After the uploaded information is received, the cloud server determines using the unique identifier, encrypted information stored in a database is consistent with the encrypted information to be verified, and if inconsistent, the cloud server automatically sends alarm information to a document copyright owner.

### TECHNICAL FIELD

The present invention relates to a technical field of digital copyright protection, in particular to a method for automatically alerting after an encrypted document is revealed.

### BACKGROUND OF THE INVENTION

Digital Rights Management (DRM) is to use a computing method to protect a digital content, to realize prevention of illegal copying of a digital content, or to make copying difficult and costly. To use the digital content, the end user must be authorized. The user's use of digital content is carried out under the constraints specified by the DRM system. DRM technology mainly considers beforehand the use of technical means to prevent documents from being illegally transmitted. But if the document is really illegally cracked, can we have a way to be reminded instantly after the event and take possible remedies? The existing DRM system basically does not have such a function of reminding afterwards.

### SUMMARY OF THE INVENTION

The invention provides a method for automatically alerting after an encrypted document is revealed, the copyright owner can be reminded immediately when the document is cracked.

To achieve the above object, the present invention provides a method for automatically alerting after an encrypted document is revealed, comprising following steps:

Establishing a unique identifier for each protected document, and setting the unique identifier of the document in the document;

Uploading the unique identifier of the document to a cloud server, the cloud server storing the encryption information corresponding to each document by using the unique identifier of the document as an index, wherein the encryption information comprises: whether the document is encrypted and which system is used for encryption;

When the third-party DRM system is used to encrypts the document, the third-party DRM system uploading the unique identifier of the document and current encryption information of the document to the cloud server, and the cloud server updating the encryption information of the document;

When the user opens the document in the document reading client, the document reading client automatically uploading the unique identifier of the document and the encryption information to be verified to the cloud server;

After receiving the unique identifier of the document and the encryption information to be verified uploaded by the document reading client, the cloud server determining, by using the unique identifier, whether the encryption information stored in the database is consistent with the encryption information to be verified; If they are consistent, the document is not cracked, and if not, the document may be cracked, then the cloud server automatically sending an alert message to a copyright owner of the document.

Further, the document is a PDF document.

The invention can detect whether the document is cracked and remind the copyright owner immediately when the document under digital right protection is cracked, this improves the efficiency of copyright protection, so that the loss can be controlled to a minimum.

### BRIEF DESCRIPTION OF THE DRAWINGS

In order to more clearly illustrate the embodiment of the present invention or the technical solutions in the prior art, the drawing used in the embodiment or the description of the prior art will be briefly described below. Obviously, the drawing in the following description is only a certain embodiment of the present invention, and other drawings can be obtained by those ordinary technicians skilled in the art on the basis of the drawing without any creative labor.

FIG. 1 is a flowchart of a method for automatically alerting after an encrypted document is revealed according to an embodiment of the present invention.

### DETAILED DESCRIPTION OF THE PREFERRED EMBODIMENTS

The technical solutions in the embodiment of the present invention are clearly and entirely described in the following with reference to the attached drawing in an embodiment of the present invention. It is obvious that the described embodiment is only a part of the embodiment of the present invention, but not all embodiments. All other embodiments obtained by ordinary technicians skill in the art without paying productive labor are in the protective scope of the present invention.

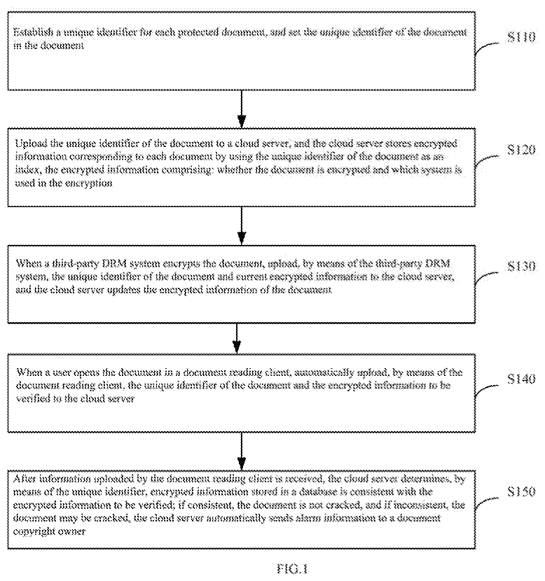

FIG. 1 is a flowchart of a method for automatically alerting after an encrypted document is revealed according to an embodiment of the present invention. As shown in the FIGURE, following steps are included:

S110, establishing a unique identifier for each protected document, and setting document the unique identifier of the document in the document;

S120: Uploading the unique identifier of the document to the cloud server, the cloud server storing the encryption information corresponding to each document by using the unique identifier of the document as an index, wherein the encryption information comprises: whether the document is encrypted and which system is used for encryption;

S130, when the third-party DRM system is used to encrypt the document, the third-party DRM system uploading the unique identifier of the document and current encryption information of the document to the cloud server, and the cloud server updating the encryption information of the document.

S140, when a user opens the document in the document reading client, the document reading client automatically uploading the unique identifier of the document and the encryption information to be verified to the cloud server;

S150. After receiving the unique identifier of the document and the encryption information to be verified uploaded by the document reading client, the cloud server determining, by using the unique identifier, whether the encryption information stored in the database is consistent with the encryption information to be verified. If these are consistent, the document is not cracked; if not, the document might be cracked, and the cloud server automatically sending an alert message to the copyright owner of the document.

The following is a detailed description using a PDF document as an example.

PDF document standard stipulates that the document can be appropriately extended, and a unique identifier can be established for a PDF document at its source and written into the document. This identifier will always exist in this document. A document server is created, and a database is created in the server. The database uses the unique identifier of the document as an index, to store the encryption information of the document, such as whether it is encrypted or not, what system it is used for encryption. When the third-party DRM system encrypts the document and keeps the existing DRM process unchanged, it only needs to connect to the document server to inform it that the document has been encrypted by this DRM system. The PDF reading client needs to automatically upload the unique identifier and the encryption information of the document to the server when the user opens the document. The server uses the unique identifier of the document to compare whether the encryption information of the document stored in the database and that uploaded are consistent. If they are consistent, the document is not cracked. If they are inconsistent, this indicates that the system may be cracked, an alert is sent to the document copyright owner. The process is as follows:

1. Create a unique identifier for the PDF document DocA and write the identifier to DocA;

2. Create a document server ServerA for storing the unique identifier of DocA and the encryption status information of DocA, such as whether it is encrypted and what system it is used to encrypt.

3. The third-party DRM system does not need to change the existing DRM process when encrypting DocA, but it needs to connect to ServerA to inform that DocA has been encrypted by the system.

4. The reading client of the PDF automatically uploads the unique identification and the encryption information of the document to ServerA when the user opens DocA.

5. by using the unique identifier of the document as an index, ServerA compares the encryption information of the document stored in the database with the encryption information uploaded in step 4, if they are consistent, the document is not cracked. If they are inconsistent, this indicates that the document might be cracked, an alert is sent to the copyright owner of the document.

The invention detects instantly that the digital rights document is cracked and remind the copyright owner. This improves the efficiency of copyright protection, so that the loss due to crack-down of the document can be controlled to a minimum.

It will be understood by those ordinary technicians skill in the art that the drawings are only a schematic diagram of an embodiment, and the modules or processes in the drawing are not necessarily required to implement the invention.

It will be understood by those ordinary technicians skilled in the art that the modules in the devices in the embodiment may be distributed in the devices of the embodiments according to the descriptions of the embodiments, or may be correspondingly changed in one or more devices different from this embodiment. The modules of the above embodiment may be combined into one module, or may be further split into multiple sub-modules.

Finally it should be noted that the above embodiment is only used to illustrate the technical solutions of the present invention, and is not limited thereto; although the present invention has been described in detail with reference to the foregoing embodiment, those ordinary technicians skilled in the art should understand that the technical solutions described in the foregoing embodiment can be modified, or the technical features can be replaced by the equivalents; these modifications and substitutions will not cause the nature of the corresponding technical solution to depart from the spirit and scope of the technical solutions of the embodiments of the present invention.

1. A method for automatically alerting after an encrypted document is revealed, comprising the following steps:
establishing a unique identifier for each protected document, and setting the unique identifier of the document in the document;
uploading the unique identifier of the document to a cloud server, the cloud server storing the encryption information corresponding to each document by using the unique identifier of the document as an index, wherein the encryption information comprises: whether the document is encrypted and which system is used for encryption;
when a third-party DRM system is used to encrypt the document, the third-party DRM system uploading the unique identifier of the document and current encryption information of the document to the cloud server, and the cloud server updating the encryption information of the document;
when the user opens the document in a document reading client, the document reading client automatically uploading the unique identifier of the document and the encryption information to be verified to the cloud server;
after receiving the unique identifier of the document and the encryption information to be verified uploaded by the document reading client, the cloud server determining, by using the unique identifier, whether the encryption information stored in the database is consistent with the encryption information to be verified; if they are consistent, the document is not cracked, and if not, the document may be cracked, then the cloud server automatically sending an alert message to a copyright owner of the document.

2. The method of claim 1 for automatically alerting after an encrypted document is revealed, wherein the document is a PDF document.
